(19) United States
(12) Patent Application Publication
(10) Pub. No.: US 2026/0061963 A1
(43) Pub. Date: Mar. 5, 2026

(54) SEATBELT RETRACTOR

(71) Applicant: ZF Passive Safety Systems US Inc., Washington, MI (US)

(72) Inventors: Robert Morgan, Allenton, MI (US); Scott Franz, Clinton Township, MI (US); Andrew Schneider, Metamora, MI (US)

(21) Appl. No.: 18/815,941

(22) Filed: Aug. 27, 2024

(51) Int. Cl. B60R 22/34; B60R 22/415

(52) U.S. Cl. CPC B60R 22/3413; B60R 22/415

(57) ABSTRACT

A seatbelt retractor for a vehicle seatbelt webbing includes a frame. A locking disk is rotatable relative to the frame. A spool is rotatably mounted to the frame and is configured to have the seatbelt webbing wound thereon. A torsion bar is connected to the locking disk and the spool. A band is connected to the locking disk and the spool. The seatbelt retractor has a first state in which the torsion bar and the band each deform to at least partially absorb a load on the seatbelt webbing when the spool rotates relative to the locking disk. The seatbelt retractor has a second state in which the band alone deforms to at least partially absorb the load on the seatbelt webbing when the spool rotates relative to the locking disk. The seatbelt retractor is configured to switch from the first state to the second state.

### TECHNICAL FIELD

The present invention relates to a seatbelt retractor for a vehicle seatbelt webbing.

### BACKGROUND OF THE INVENTION

Known belt retractors for a vehicle seatbelt webbing include a frame, a spool rotatably mounted on the frame, a primary seatbelt webbing load absorption element and a secondary load absorption element. In certain seatbelt retractors, the primary seatbelt load absorption element is a torsion bar, and the secondary load absorption element is at least one band. During an emergency state of the vehicle (e.g., during a high-speed collision), the torsion bar and the at least one band deform to at least partially absorb a seatbelt webbing load. After a condition is met (e.g., the spool rotates to a predetermined degree), the at least one band is deactivated, leaving only the torsion bar to deform and absorb seatbelt webbing load.

### SUMMARY OF THE INVENTION

According to an aspect of the invention, alone or in combination with any other aspect, a seatbelt retractor for a vehicle seatbelt webbing comprises a frame. A locking disk is rotatable relative to the frame. A spool is rotatably mounted to the frame and is configured to have the seatbelt webbing wound thereon. A torsion bar is connected to the locking disk and the spool. A band is connected to the locking disk and the spool. The seatbelt retractor has a first state in which the torsion bar and the band each deform to at least partially absorb a load on the seatbelt webbing when the spool rotates relative to the locking disk. The seatbelt retractor has a second state in which the band alone deforms to at least partially absorb the load on the seatbelt webbing when the spool rotates relative to the locking disk. The seatbelt retractor is configured to switch from the first state to the second state.

According to an aspect of the invention, alone or in combination with any other aspect, the seatbelt retractor is configured to switch from the first state to the second state via a disconnection of the torsion bar from one of the locking disk and the spool.

According to an aspect of the invention, alone or in combination with any other aspect, each band of the seatbelt retractor remains connected to the spool and the locking disk during use of the seatbelt retractor.

According to an aspect of the invention, alone or in combination with any other aspect, the seatbelt retractor includes only one band that is connected to the locking disk and the spool and that deforms to at least partially absorb the load on the seatbelt webbing in the emergency state.

According to an aspect of the invention, alone or in combination with any other aspect, the band includes opposite first and second end portions and an intermediate portion extending along a length of the band between the first and second end portions. The first and second end portions are connected to the spool. The intermediate portion of the band is fixed to a hub of the locking disk. The first and second end portions deform and wind about the hub as the spool rotates relative to the locking disk.

According to an aspect of the invention, alone or in combination with any other aspect, the seatbelt retractor, in one use configuration, operates only in the second state without previously or subsequently operating in the first state.

According to an aspect of the invention, alone or in combination with any other aspect, a seatbelt retractor for a vehicle seatbelt webbing comprises a frame. A locking disk is rotatable relative to the frame. The locking disk is prevented from rotating relative to the frame in an emergency state of a vehicle. A spool is rotatably mounted to the frame and is configured to have the seatbelt webbing wound thereon. The spool rotates about an axis with the locking disk in a normal state of the vehicle and relative to the locking disk in the emergency state of the vehicle. A torsion bar is connected to the locking disk and the spool such that the torsion bar rotates with the locking disk and the spool relative to the frame in the normal state. Rotation of the spool relative to the locking disk deforms the torsion bar. A band is connected to the locking disk and the spool such that rotation of the spool relative to locking disk deforms the band. The seatbelt retractor has a first state in which the torsion bar and the band each deform to at least partially absorb a load on the seatbelt webbing. The seatbelt retractor has a second state in which the band alone deforms to at least partially absorb the load on the seatbelt webbing. The seatbelt retractor is configured to switch from the first state to the second state.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 is a perspective side view of a seatbelt retractor according to an example embodiment of the present disclosure;

FIG. 2 is a cross-sectional view of the seat belt retractor of FIG. 1;

FIG. 3 is a rear exploded view of a portion of the seatbelt retractor of FIG. 1;

FIG. 4 is a front exploded view of the portion shown in FIG. 3;

FIG. 5 is a front cross-sectional view of a portion of the seatbelt retractor of FIG. 1;

FIG. 6 is a rear cross-sectional view of a portion of the seatbelt retractor of FIG. 1;

FIG. 7 is a front cross-sectional view of an alternate configuration of a portion of the seatbelt retractor of FIG. 1;

FIG. 8 is graph showing seatbelt webbing load vs. webbing extension length;

FIG. 9 is a top view of a band of the seatbelt retractor of FIG. 1 in a pre-assembled state, including the band in a first configuration;

FIG. 10 is a top view of a band of the seatbelt retractor of FIG. 1 in a pre-assembled state, including the band in an alternate configuration;

FIG. 11 is a top view of a band of the seatbelt retractor of FIG. 1 in a pre-assembled state, including the band in an alternate configuration;

FIG. 12 is a graph showing seatbelt webbing load vs webbing extension length, including curves corresponding to the band configurations of FIGS. 9-11;

FIG. 13 is a top view of a band of the seatbelt retractor of FIG. 1 in a pre-assembled state, including the band in an alternate configuration;

FIG. 14 is a cross-sectional view of a band of the seatbelt retractor of FIG. 1, including the band having a first cross-sectional shape; and

FIG. 15 is a cross-sectional view of a band of the seatbelt retractor of FIG. 1, including the band having an alternate cross-sectional shape.

### DETAILED DESCRIPTION

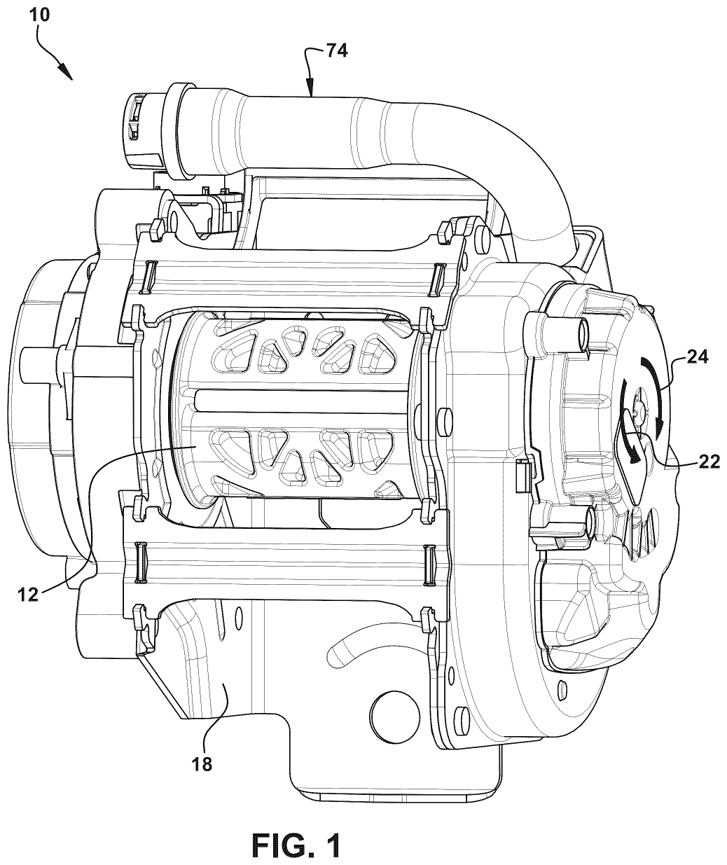

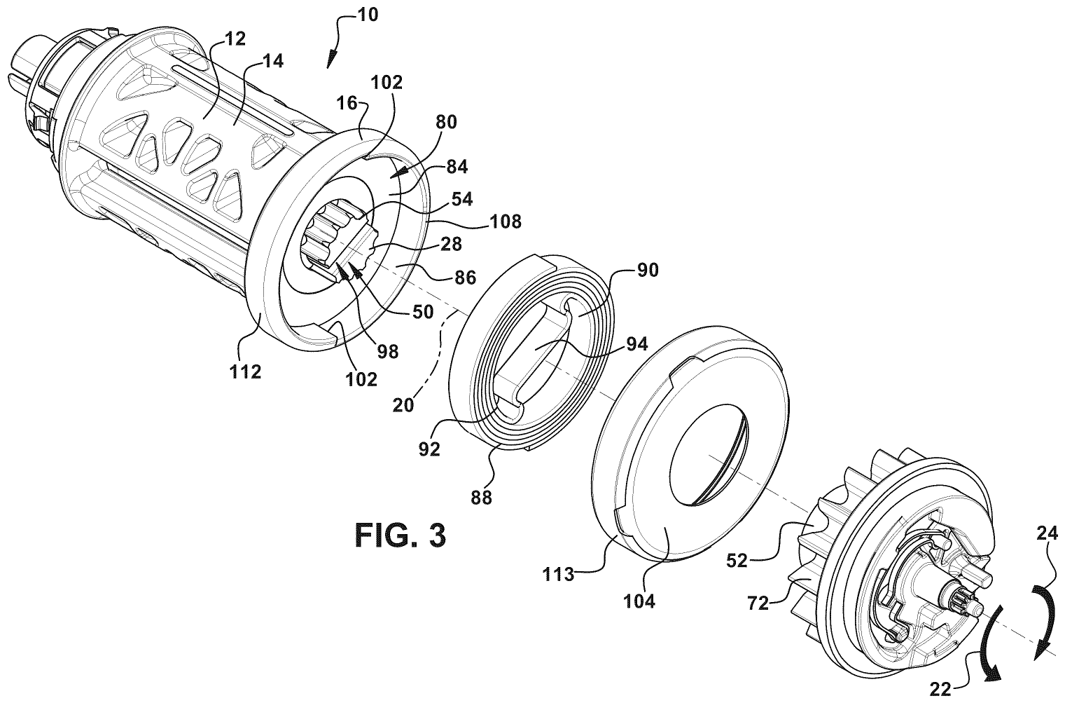

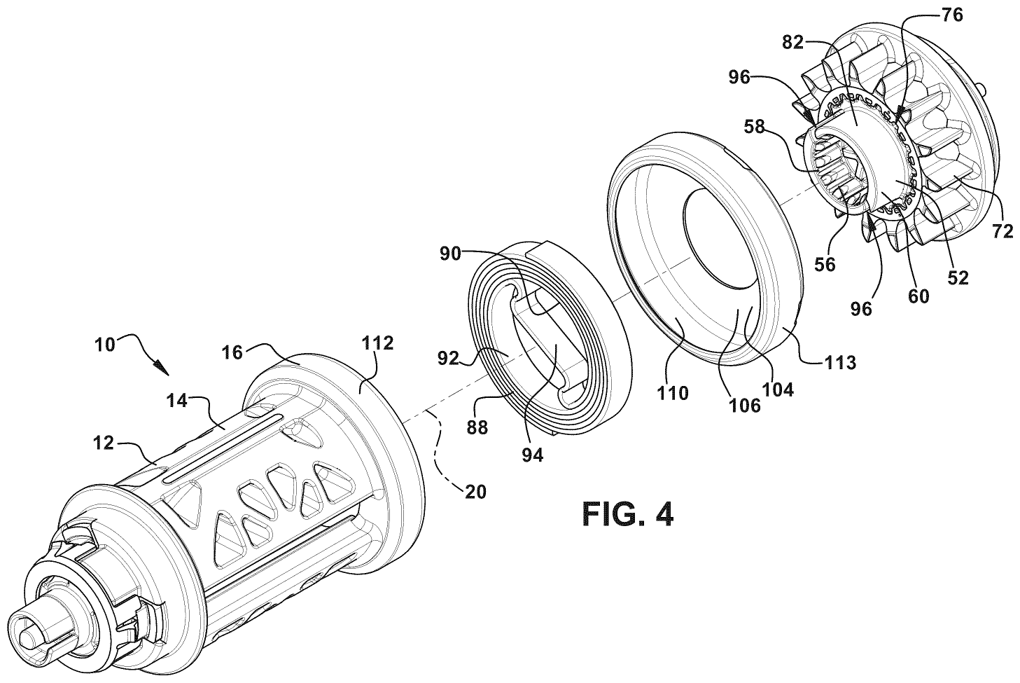

FIGS. 1-6 illustrate an example seatbelt retractor 10 design in accordance with the present disclosure. The seatbelt retractor 10 includes a spool 12 having a first cylinder portion 14 and a second cylinder portion 16 formed in one-piece with the first cylinder portion. The second cylinder portion 16 has larger outer and inner diameters than that of the first cylinder portion 14.

The spool 12 is rotatably mounted to a frame 18 so that a length of seatbelt webbing (not shown for reasons of clarity) can be wound on and unwound from the spool (e.g., wound and unwound on the first cylinder portion 14). More particularly, the spool 12 is rotatable about an axis 20 in a webbing withdrawal direction 22 and an opposite webbing retraction direction 24. A biasing member (e.g., a spring) 26 may act on the spool 12 to bias the spool in the webbing retraction direction 24.

A torsion bar 28 extends in an axial direction through an interior of the spool 12. A first end 30 of the torsion bar 28 is removably connected to the spool 12 such that the first end rotates with (i.e., not relative to) the spool when connected thereto. For example, the first end 30 may be removably coupled to the spool 12 via a switching mechanism 32. The switching mechanism 32 may be or may be a modified version of the switching mechanism shown and described in U.S. Pat. No. 10,919,487 to Daeuber et al. (‘the '487 patent”), the subject matter of which is incorporated by reference in its entirety, though the switching mechanism 32 may be any other known mechanism configured for removably connecting the torsion bar 28 to, e.g., the spool 12. As such, the switching mechanism 32 may include at least one bar 34 (here, a plurality of bars 34) that removably engages teeth 36 of the first end 30 of the torsion bar 28. The bars 34 are arranged in corresponding recesses 38 of the spool 12 and retained in the recesses via a support ring 40. The support ring 40 is fixed on the spool 12 via a holder 42. Therefore, the first end 30 of the torsion bar 28 is removably connected to the spool 12 via the bars 34, the support ring 40, and the holder 42 of the switching mechanism 32 when the bars engage the teeth 36.

In order to release the coupling between the spool 12 and the torsion bar 28, the support ring 40 may be displaced in the axial direction until the support ring stops supporting the bars 34 in the axial direction. For this purpose, the switching mechanism 32 also includes a case 44 that is mounted to the frame 18, a lifting ring 46 rotatably mounted in the case and a gas generator 48 (e.g., a micro-gas generator) mounted to the case. The lifting ring 46 is driven by the gas generator 48 and interacts with one or more interior lifting features in/of the case 44 (e.g., lifting ramps) in the same or similar manner as described in the '487 patent. Therefore, when the gas generator 48 is actuated, the lifting ring 46 is rotated about the axis 20 relative to the case 44. The rotating lifting ring 46 is urged in the axial direction via the lifting ring's interaction with the lifting features. The support ring 40 is moved axially relative to the holder 42 via the axially moving lifting ring 46. The axially displaced support ring 40 ceases to support the bars 34 in the axial direction, which permits the bars to move radially outward and disengage the teeth 36 of the torsion bar 28 when a torque is transmitted between the spool 12 and the torsion bar.

A second end 50 of the torsion bar 28 is rotationally fixed to a locking disk 52 such that the second end rotates with the locking disk. For example, the second end 50 may be rotationally fixed to the locking disk 52 via splines 54 that are received in grooves 56 on or adjacent to an inner periphery 58 of a hub 60 (e.g., a cylindrically or spirally shaped hub) of the locking disk. Although seatbelt retractor 10 is configured having the torsion bar 28 removably connected to the spool 12 and rotationally fixed to the locking disk 52, the seatbelt retractor may instead be configured having the torsion bar removably connected to the locking disk via a switching mechanism 32 and rotationally fixed to the spool.

The locking disk 52 is but one part of a locking mechanism 62 that is configured to block a rotational movement of the spool 12 relative to the frame 18 in the webbing withdrawal direction 22 under certain conditions. The locking mechanism 62 also includes a pawl 64 that has an end pivotably mounted to the locking disk 52. By means of a conventional locking mechanism (such as the one shown and described in U.S. Pat. No. 10,315,617 to Franz et al. (“the '617 patent”), the subject matter of which is incorporated by reference in its entirety), the pawl 64 can be pivoted from a rest position into engagement with teeth 66 that are formed about an opening 68 in a supplemental portion 70 of the frame 18. Rotational movement of the locking disk 52 relative to the frame 18 in the webbing withdrawal direction 22 is blocked after (e.g., immediately or almost immediately after) the pawl 64 engages the frame teeth 66. Further, as a result of the inter-engagement between the grooves 56 in the locking disk 52 and the splines 54 on the torsion bar 28, rotation of the second end 50 of the torsion bar in the webbing withdrawal direction 22 is also blocked. The spool 12, when connected to the first end 30 of the torsion bar 28, is at least partially restricted from rotating in the webbing withdrawal direction 22 when the torsion bar is blocked from rotating in the webbing withdrawal direction. The torsion bar 28 thus operatively connects the spool 12 to the locking mechanism 62.

A turbine wheel 72 of a pretensioner 74 is rotationally fixed to the locking disk 52 so that the turbine wheel and the locking disk rotate with one another. The turbine wheel 72 is formed separately from the locking disk 52 and subsequently attached to an outer periphery 76 of the locking disk in a rotationally fixed manner, though the turbine wheel and the locking disk may have a one-piece construction so as to be rotationally fixed to one another. Although not shown in detail, the pretensioner 74 includes a tube 78 that houses a gas generator (e.g., a micro-gas generator) and one or more features that rotate the turbine wheel 72 in the webbing retraction direction 24 in response to actuation of the gas generator. An example of such a pretensioner is shown and described in the '617 patent. Rotation of the turbine wheel 72 is transmitted to the spool 12 via the locking disk 52 and the torsion bar 28 and thereby causes the spool to rotate in the webbing retraction direction 24 to wind up the seatbelt webbing on the spool. The winding rotation of the spool 12 effectively reduces or eliminates slack in the seatbelt webbing wound on the spool and also pulls the seatbelt webbing closely and tightly against a vehicle occupant (not shown).

At least a portion of the hub 60 extends into the second cylinder portion 16 such that an annular cavity 80 is defined between an outer periphery 82 of the hub, an inner axial surface 84 of the second cylinder portion and an inner periphery 86 of the second cylinder portion. The seatbelt retractor 10 includes at least one band 88 that is at least partially positioned within the cavity 80. In the example configuration shown in FIGS. 1-6, the seatbelt retractor 10 includes only one band 88 that extends substantially within the cavity 80.

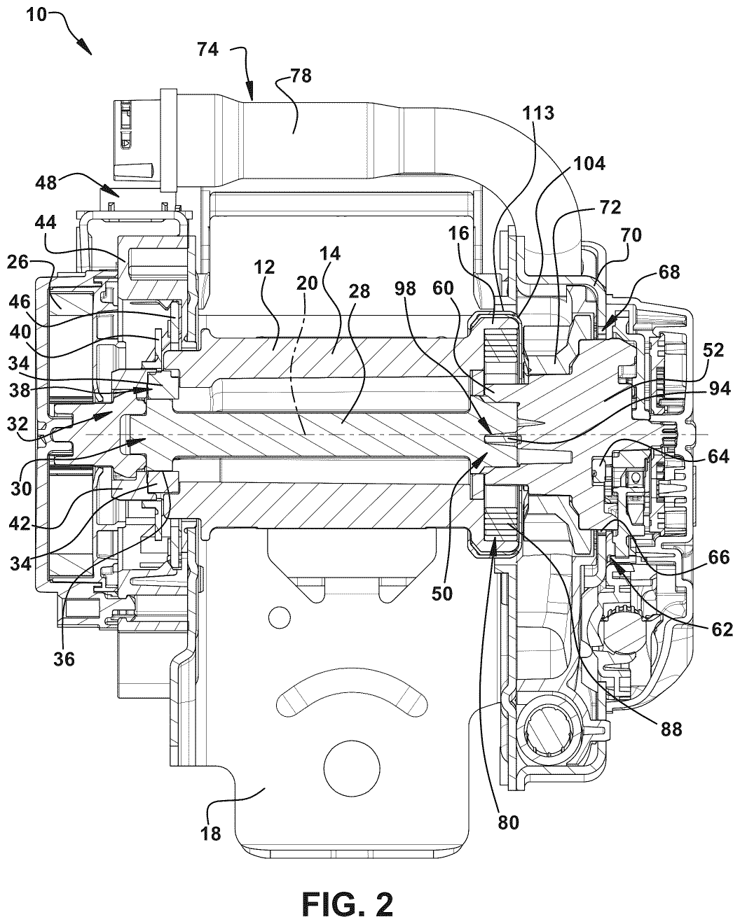

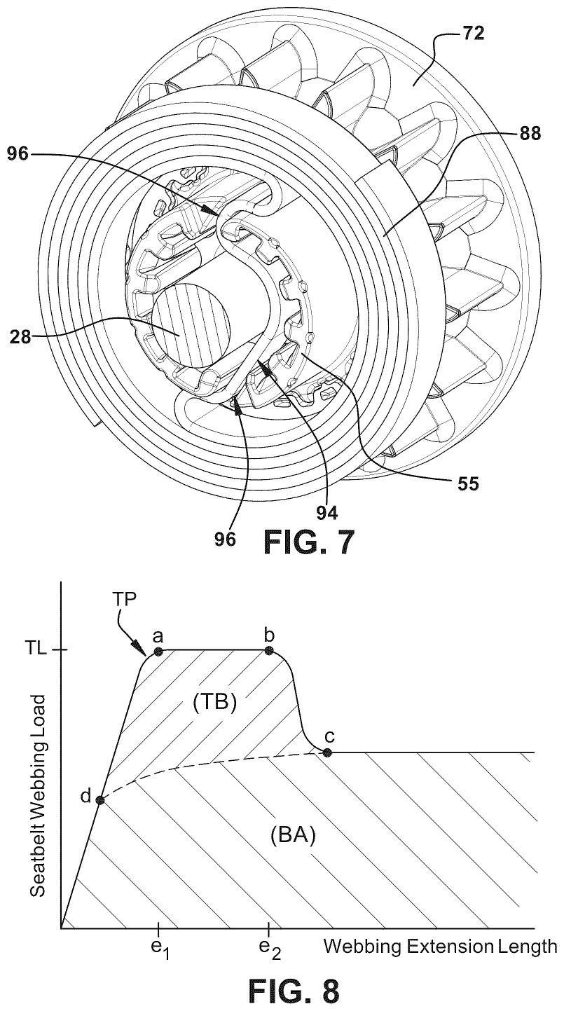

The band 88 includes opposite first and second end portions 90, 92 and an intermediate portion 94 extending along a length of the band between the first and second end portions. The intermediate portion 94 is rotationally fixed to the locking disk 52 (e.g., to the hub 60) in the second cylinder portion 16. In particular, the intermediate portion 94 is positioned in an interior of the hub 60 and extends out from the hub through two diametrically arranged slots 96 in the hub. The first intermediate portion 94 thus extends in a first direction through a first one of the slots 96 to the first end portion 90, and in an opposite second direction through a second one of the slots 96 to the second end portion 92. The intermediate portion 94 may also be routed through a slot 98 in the torsion bar 28 (see, e.g., FIGS. 2, 5 and 6), though the intermediate portion may instead be routed about the torsion bar in an alternate configuration of the belt retractor 10 (see, e.g., FIG. 7).

The first end portion 90 of the band 88 extends from the intermediate portion 94 circumferentially around the outer periphery 82 of the hub 60 in the webbing withdrawal direction 22 to form a first or internal segment S1. Then, the first end portion 90 makes a U-turn to form a U-turn segment S2 in the cavity 80. After making the U-turn, the first end portion 90 extends and is spirally wound in the webbing retraction direction 24 to form a second or external segment S3. The external segment S3 terminates at a circumferentially facing and axially extending end face 100 that engages the spool 12. In particular, the end face 100 circumferentially abuts a complementary inner shoulder 102 of the inner periphery 86. The inner shoulder 102 is formed by a radial drop-off on the inner periphery 86 of the second cylinder portion 16.

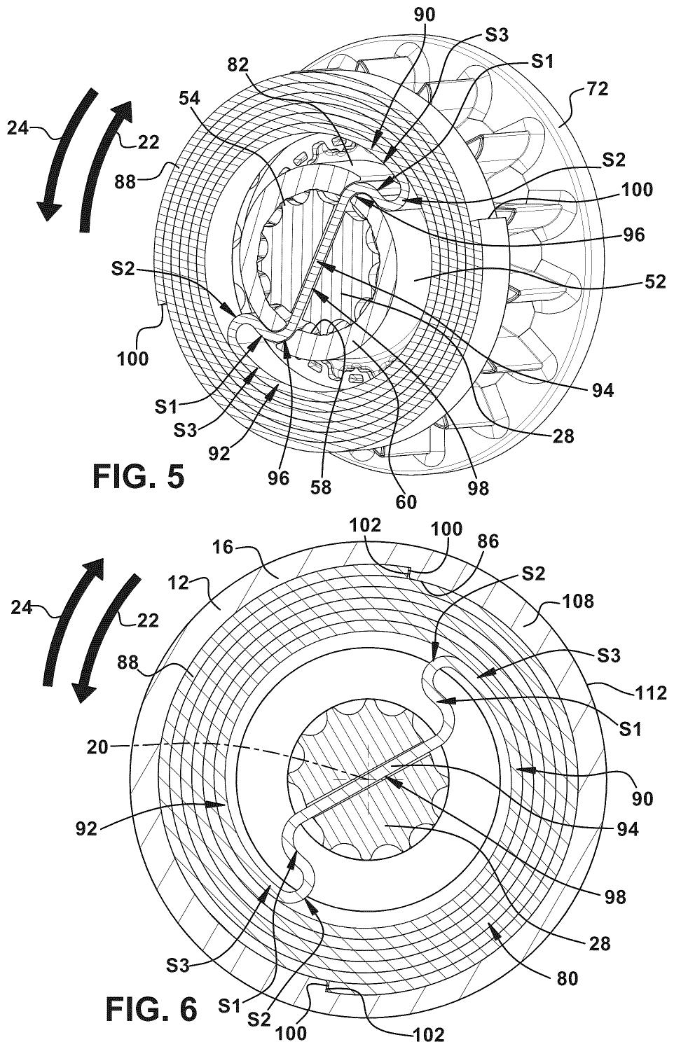

The second end portion 92 of the band 88 is structurally identical (or at least substantially structurally identical) to the first end portion 90 of the band and, thus, is arranged in the seatbelt retractor 10 in the same or similar manner as the first end portion. Accordingly, the above description of the first end portion 90 applies to the second end portion 92. The U-turn segments 82 and end faces 100 of the first and second end portions 90, 92, however, are disposed symmetrically with respect to the axis 20. In this way, a symmetrical load distribution is obtained on the spool 12 via the locking disk 52 and the torsion bar 28. As shown in FIGS. 5-6, the lengths of the first and second end portions 90, 92 (which is measured from the end faces 100 to the intermediate portion 94) may be such that first and second end portions overlap one another as they are spirally wound. Such overlap does not inhibit the functionality of either of the first and second end portions 90, 92.

The seatbelt retractor 10 may also include a cover 104 for helping to retain the band 88 in the second cylinder portion 16 during use. The cover 104 may be connected to the spool 12 in a rotationally-fixed manner, or connected to the spool in a manner which allows relative rotation between the spool and the cover. When connected to the spool 12, a spool-side inner axial surface 106 of the cover 104 is adjacent to and/or abuts an outer axial surface 108 of the second cylinder portion 16. An inner circumferential surface 110 of the cover 104, which extends axially from the inner axial surface 106, may be adjacent to and/or abut at least an outer periphery 112 of the second cylinder portion 16 when connected thereto. The cover 104 thus encompasses at least a portion of the second cylinder portion 16 when connected to the spool 12. In other words, the cover 104 axially covers the second cylinder portion 16 on the axial side of the second cylinder portion 16 that includes the outer axial surface 108 and circumferentially covers the second cylinder portion about its outer periphery 112. It should be noted that any contact between the cover 104 and the spool 12 does not (or does not significantly) restrict the rotation of the spool, the rotation of the locking disk 52, or any relative rotation between the spool and the locking disk. When the cover 104 is provided and connected to the spool 12, the axial surface 106 of the cover defines the cavity 80 together with the outer periphery 82 of the hub 60, the inner axial surface 84 of the second cylinder portion 16 and the inner periphery 86 of the second cylinder portion.

A plastic bearing 113, which is separate from the cover 104, may be provided on the cover. The plastic bearing 113 may be provided to reduce friction in the seatbelt retractor 10 so as to aid in the development of smooth load curves for the seatbelt retractor.

In use, when the retractor 10 is installed in a vehicle (not shown), the occupant grasps a buckle tongue (not shown) that is attached to the seatbelt webbing wound on the spool 12 and pulls the buckle tongue and the seatbelt webbing away from the retractor in order to don the seatbelt by drawing the seatbelt webbing across the occupant's body and connecting the buckle tongue to a buckle (not shown). As the seatbelt webbing is pulled away from the retractor 10, the webbing unwinds from the spool 12 and rotates the spool in the webbing withdrawal direction 22 against the bias of the biasing member 26. Because the spool 12 is connected to the torsion bar 28, and the torsion bar is connected to the locking disk 52, rotation of the spool effects rotation of the locking disk in the webbing withdrawal direction 22.

After the seatbelt has been donned by the occupant, subsequent low acceleration, low speed withdrawal and retraction movements of the seatbelt webbing in a normal state of the vehicle, as, for example, when the occupant adjusts his or her position in a vehicle seat (not shown), will produce low acceleration rotational movements of the spool 12 and consequent joint rotational movements of the locking disk 52.

In an emergency state of the vehicle (e.g., during a high-speed collision), the pretensioner 74 and the locking mechanism 62 may be actuated. The pretensioner 74 may be actuated in response to a vehicle sensor (not shown), such as an accelerometer mounted in the vehicle, detecting a rapid deceleration of the vehicle indicating the occurrence of the emergency state. The pretensioner 74 may alternatively or additionally be actuated in response to a vehicle sensor (not shown), such as a forward-looking radar unit or a forward-looking camera, detecting an anticipated and potentially unavoidable emergency state. The pretensioner 74 may alternatively or additionally be actuated in response to a vehicle sensor (not shown), such as a camera or a capacitive sensor directed toward or located adjacent to the occupant, detecting movement of the occupant indicating the occurrence of the emergency state. Any desired system or mechanism may be used to determine whether and when to actuate the pretensioner 74.

Actuation of the pretensioner 74 starts with actuation of the pretensioner's gas generator. When actuated, the gas generator produces or generates gas, which pushes one or more features against the turbine wheel 72, thereby rotating the turbine wheel in the webbing retraction direction 24. Rotation of the turbine wheel 52 is transmitted to the spool 12 via the locking disk 52 and the torsion bar 28 and, thus, causes the spool to rotate in the webbing retraction direction 24 to wind up the seatbelt webbing on the spool. Such winding rotation of the spool 12 effectively reduces or eliminates slack in the seatbelt webbing wound on the spool and also pulls the seatbelt webbing tightly against the occupant.

The occupant, however, in the emergency state, may move against the seatbelt webbing, which extends across the occupant's body. Such occupant movement, after operation of the pretensioner 74 is completed, will impose a load on the seatbelt webbing and urge the spool 12 to accelerate in the webbing withdrawal direction 22. The locking mechanism 52 may be configured such that, under such spool acceleration, the pawl 64 is pivoted from the rest position to a position in which the pawl engages the frame's teeth 66 to prevent further rotation of the locking disk 52 and the second end 50 of the torsion bar 28 in the webbing withdrawal direction 22. Therefore, the locking disk 52 is rotationally locked to the frame 18 (e.g., to the supplemental portion 70 of the frame) via the pawl 64 when the pawl engages the frame's teeth 66.

However, because the vehicle is in an emergency state, the load in the seatbelt webbing is likely to be sufficient to urge the spool 12 to rotate in the webbing withdrawal direction 22 relative to the locking disk 52. Such relative rotation urges the torsion bar 28 to twist and deform (e.g., plastically deform) because the spool 12 urges the first end 30 of the torsion bar to rotate relative to the second end 50. Therefore, the deformability of the torsion bar 28 permits the spool 12 to rotate relative to the locking disk 52 in the emergency state. The deformation of the torsion bar 28 absorbs at least a portion of the load in the seatbelt webbing.

With this relative movement, the band 88 provided between the locking disk 52, which is in a rotationally locked state, and the spool 12, which is rotating relative to the locking disk, deform (e.g., deform plastically) and is wound around the outer periphery 82 of the hub 60 in the webbing withdrawal direction 22. In particular, the end faces 100 of the first and second end portions 90, 92 are urged and/or pushed by the inner shoulders 102 of the second cylinder portion 16 in the webbing withdrawal direction 22, which urges the first and second end portions to plastically deform and wind around the hub 60. Because the first and second end portions 90, 92 have the same or a substantially similar structure and are arranged in the retractor 10 in the same or a substantially similar manner, the first and second end portions are deformed together and at the same time, though the retractor 10 may be configured such that one of the first and second end portions deforms ahead of the other. This deformation of the band 88 further absorbs the seatbelt webbing load.

As the first and second end portions 90, 92 are wound around the outer periphery 82 of the hub 60, the lengths of their internal segments S1 increase and their U-turn segments S2 are displaced in the webbing withdrawal direction 22. The overlapping and spirally wound arrangement of the first and second end portions 90, 92 may cause a radial length of the U-turn segments S2 to decrease as the U-turn segments are displaced in the webbing withdrawal direction 22. The winding of the first and second end portions 90, 92 also shortens the external segments S3. The winding and deformation of the band 88 and the changes to the segments S1, S2, S3 continues in this manner throughout the entirety of the emergency state. In other words, the band 88 remains connected to the spool 12 and the locking disk 52 during use, never disconnecting from either of the spool or the locking disk so that the band absorbs (or is a condition to absorb) seatbelt webbing load throughout the entirety of the emergency state.

Once the rotation of the spool 12 relative to locking disk 52 reaches a predetermined degree, a predetermined amount of time has elapsed since the start of the emergency state and/or the relative rotation of the spool to the locking disk, and/or a predetermined amount of webbing has been paid out of the seatbelt retractor 10, the gas generator 48 of the switching mechanism 32 is actuated to cause the first end 30 of the torsion bar 28 to disconnect from the spool. Once disconnected from the spool 12, the first end 30 of the torsion bar 28 ceases to rotate relative to the locking disk 52 and, thus, the torsion bar ceases to absorb the load in the seatbelt webbing, leaving only the band 88 to do so.

When the spool 12 rotates relative to the second end 50 of the torsion bar 28 in the webbing withdrawal direction 22 and twists the torsion bar, deformation of the torsion bar and the band 88 functions to absorb seatbelt webbing load. The entire absorption load of the seatbelt retractor 10 is a sum of the absorption load when the torsion bar 28 twists and deforms and the absorption load when the band 88 deforms and is wrapped around the hub 60. Via the entire absorption load, impact energy applied to the moving occupant via the seatbelt webbing is absorbed and eased, and the load applied to the seatbelt webbing is restricted.

By way of the graph in FIG. 8, the effect of the load absorption and limitation provided by the torsion bar 28 and the band 88 on the seatbelt webbing can be visualized. In the graph of FIG. 8, the vertical axis shows the seatbelt webbing load and the horizontal axis shows an extension (i.e., payout) length of the webbing.

As shown in FIG. 8, the seatbelt webbing load builds until it reaches (or is close to reaching) a predetermined target load (shown as TL in FIG. 8), which is the load at which the spool 12 is able to rotate relative to the locking disk 52 against the internal bias of the torsion bar 28 and the band 88. Therefore, once the target load TL is reached and the relative rotation begins, the torsion bar 28 and the band 88 act in parallel (i.e., twist and/or deform) so that the seatbelt webbing load stops increasing and is maintained at the target load TL (point a to point b in FIG. 8) or substantially at the fixed value despite an increase in webbing extension length. The torsion bar 28 and the band 88 thus act in parallel from a webbing extension of e₁ to e₂, during which the total load on the seatbelt is composed of a load defined by the torsion bar 14 (shown as TB in FIG. 8) and a load defined by the band 88 (shown as BA in FIG. 8). It should be noted that the load absorption characteristics of the band 88 may be tailored to produce a smooth transition from “load build-up” to “load limiting/absorption,” as is evidenced by the curved transition portion TP in FIG. 8. Such a smooth transition helps prevent the seatbelt webbing load from “overshooting”the target load TL.

When the webbing extension increases further and the first end 30 of the torsion bar 28 is disconnected from the spool 12 via the switching mechanism 32, the seatbelt webbing load drops (point b to point c in FIG. 8) because only the band 88 continues to be active. After this disconnection, the seatbelt webbing load may either maintain the dropped value or may steadily deviate (e.g., increase or decrease) from the dropped value depending on the characteristics of the band 88 as the webbing extension increases (right side from point c in FIG. 8).

As evidenced by the change in the seatbelt webbing load between points b and c in FIG. 8, the seatbelt retractor 10 directly switches (via the switching mechanism 32) from a first state, in which the band 88 and the torsion bar 28 act together to absorb at least a portion of the seatbelt webbing load, to a second state, in which the band alone acts to absorb at least a portion of the seatbelt webbing load. The seatbelt retractor 10 also switches from a high load level to a low load level via the use of non-mechanical features of the switching mechanism 32, such as, for example, pyrotechnics, though the switching mechanism may be configured such that the switch occurs without the use of pyrotechnics and/or other non-mechanical features.

The seatbelt retractor 10, in one example use configuration, may operate in the second state without having ever operated in the first state. In such case, for example, the switching mechanism 32 may be activated once the seatbelt webbing load reaches a level that corresponds to point d in FIG. 8. After the seatbelt webbing load increases to a value corresponding to point d in FIG. 8 and the switching mechanism 32 is activated, the load limitation/absorption provided by the band 88 alone causes the seatbelt webbing load to smoothly cease to increase in the same manner as it had prior to reaching point d. Depending on the load absorption characteristics of the band 88, the seatbelt webbing load may smoothly level off (shown as the dotted line in FIG. 8 and the right side from point c in FIG. 8), may smoothly increase beyond a value corresponding to point c in FIG. 8, or may smoothly decrease once the seatbelt webbing load reaches a predetermined value. It should be noted that the load absorption characteristics of the band 88 may be tailored to produce a smooth transition from “load build-up” to “load limiting/absorption,” as is evidenced by the curved transition from the build-up occurring before point d in FIG. 8 to the load-limiting/absorption after point d. Such a smooth transition helps prevent the seatbelt webbing load from “overshooting” a target load (which, in this example use configuration, is the seatbelt webbing load associated with point c in FIG. 8).

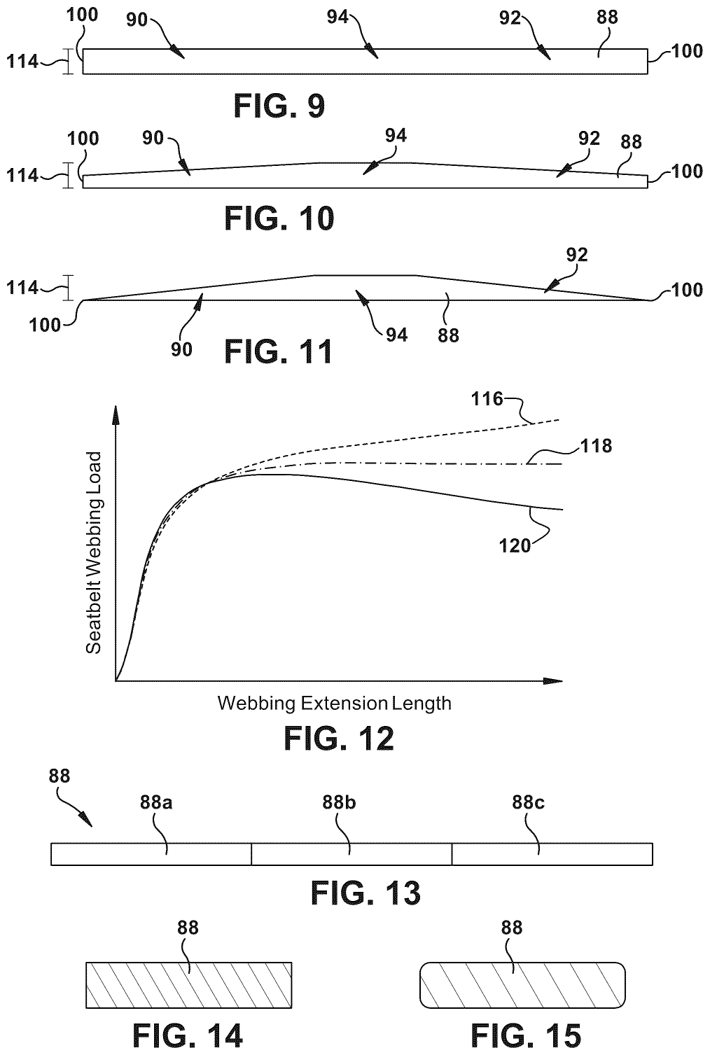

The load absorption characteristics of the seatbelt retractor 10 can be adjusted and tailored to different vehicle structures and occupant geometries. For example, the absorption load provided via the torsion bar 28 can be adjusted via changes to the torsion bar material and/or to the diametric thickness of the torsion bar. The axial width 114 and/or material properties of the band 88 can also be adjusted to achieve a desired band absorption load. For example, FIGS. 9-11 show just a few of the possible alternate configurations of the band 88 in a flattened and pre-installed condition. As shown, the axial width 114 of the band 88 may remain constant throughout the entire length of the band 88 (FIG. 9) or may vary along the length of the band (FIGS. 10-11). The variable axial width 114 of the band 88 of FIG. 10 increases steadily from each truncated-like end face 100 toward the intermediate portion 94, where it then levels off at a constant value. The variable axial width 114 of the band 88 of FIG. 11 increases steadily from each relatively sharp or pointed end face 100 toward the intermediate portion 94, where it then levels off at a constant value. FIG. 12 is a graph showing the effect each axial width configuration has on the seatbelt webbing load, where a first curve 116 corresponds to the band 88 of FIG. 9, a second curve 118 corresponds to the band 88 of FIG. 10 and a third curve 120 corresponds to the band 88 of FIG. 11.

It should be appreciated that the bands 88 of FIGS. 9-11 each produce a smooth, non-stepwise load absorption characteristic curve. A band with a stepwise load absorption characteristic curve may generate stress within a seatbelt retractor at each stepwise transition. Therefore, by having no stepwise transitions in their load absorption characteristic curves, each band 88 prevents band-related stepwise transition stress from occurring in the seatbelt retractor 10. However, in certain use environments/configurations, it may be desirable to produce a stepwise load absorption characteristic curve. In such case, the geometry and/or material(s) of the band 88 may be tailored to produce such a stepwise load absorption characteristic curve.

The material properties of the band 88 can also be adjusted to achieve a desired band absorption load. As shown in FIG. 13, the band 88 may have a plurality of segments 88a, 88b, 88c along the entire length of the band. At least one of the segments 88a, 88b, 88c may have different material properties than at least one of the other segments. For example, at least one of the segments may be subjected to a local treatment (e.g., a local heat treatment such as, but not limited to, annealing, tempering or carburizing) such that the treated segment(s) has a different strength than at least one other of the treated or non-treated segments. By adjusting the strength of one or more segments 88a, 88b, 88c, the desired band absorption load can be achieved. The treatments and strength adjustments of the band segments 88a, 88b, 88c, however, may still be configured to produce a smooth, non-stepwise load absorption characteristic curve for the segmented band 88.

The band's cross-section of the band 88 may also be tailored to minimize stress within the band and/or the seatbelt retractor 10. For example, as shown FIG. 14, the band may be rectangular in cross-section. However, in certain use environments, the sharp (or relatively sharp) corners of the band's rectangular cross-section may be stress risers for the band 88 and/or the seatbelt retractor 10. Therefore, as shown in FIG. 15, the cross-section of the band 88 may instead be shaped as a rounded rectangle in order to reduce/prevent such stress risers.

As discussed above, the spool 12 rotates or is urged rotate in the webbing withdrawal direction 22 relative to the locking disk 52 in the emergency state once the seatbelt webbing load reaches the target load. The length of the first segments S1 of the band 88 may at least partially correspond to the target load. Therefore, the length and the corresponding target load may be adjusted prior to use of the belt retractor 10 by rotating one of the spool 12 and the locking disk 52 relative to the other of the spool and the locking disk. For example, prior to use, the spool 12 may be rotated relative to the locking disk 52 to increase the length of the first segments S1. This increase in first segment length results in the target load for rotating the spool 12 relative to the locking disk 52 in the emergency state being greater than what it was prior to the length adjustment.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

Having described the invention, the following is claimed:

1. A seatbelt retractor for a vehicle seatbelt webbing, the seatbelt retractor comprising:
a frame;
a locking disk rotatable relative to the frame;
a spool rotatably mounted to the frame and on which the seatbelt webbing is wound;
a torsion bar connected to the locking disk and the spool;
a band connected to the locking disk and the spool;
a first state in which the torsion bar and the band each deform to at least partially absorb a load on the seatbelt webbing when the spool rotates relative to the locking disk; and
a second state in which the band alone deforms to at least partially absorb the load on the seatbelt webbing when the spool rotates relative to the locking disk, the seatbelt retractor being configured to switch from the first state to the second state.

2. The seatbelt retractor of claim 1, wherein the locking disk is prevented from rotating relative to the frame in an emergency state of a vehicle, the spool rotating about an axis with the locking disk in a normal state of the vehicle and relative to the locking disk in the emergency state of the vehicle.

3. The seatbelt retractor of claim 1, wherein the seatbelt retractor includes only one band that is connected to the locking disk and the spool and that deforms to at least partially absorb the load on the seatbelt webbing.

4. The seatbelt retractor according to claim 1, wherein each band of the seatbelt retractor remains connected to the spool and the locking disk during use of the seatbelt retractor.

5. The seatbelt retractor according to claim 1, wherein the seatbelt retractor switches from the first state to the second state via a disconnection of the torsion bar from one of the locking disk and the spool.

6. The seatbelt retractor according to claim 5, wherein a first end of the torsion bar is removably connected to the spool such that the first end rotates with the spool, a second end of the torsion bar being rotationally fixed to the locking disk.

7. The seatbelt retractor of claim 5, further comprising a switching device for disconnecting the torsion bar from one of the locking disk and the spool.

8. The seatbelt retractor of claim 1, wherein, in one use configuration, the seatbelt retractor operates only in the second state without previously or subsequently operating in the first state.

9. The seatbelt retractor of claim 1, wherein the band includes opposite first and second end portions and an intermediate portion extending along a length of the band between the first and second end portions, the first and second end portions being connected to the spool, the intermediate portion of the band being fixed to a hub of the locking disk, the first and second end portions deforming and winding about the hub as the spool rotates relative to the locking disk.

10. The seatbelt retractor of claim 9, wherein the first and second end portions each abut an inner shoulder of the spool, rotation of the spool relative to the locking disk urging the first and second end portions of the band to rotate relative to the intermediate portion via the inner shoulders.

11. The seatbelt retractor of claim 9, wherein the torsion bar is connected to the locking disk in an interior of the hub.

12. The seatbelt retractor of claim 9, wherein at least a portion of the hub extends into the spool such that the intermediate portion of the band is connected to the hub in the spool, a cavity in which the first and second end portions of the band at least partially extend being defined between the hub and the spool.

13. The seatbelt retractor of claim 12, further comprising a cover having an axial surface adjacent to and/or abutting an outer axial surface of the spool and a circumferential surface circumferentially surrounding an outer periphery of the spool, the cavity being defined between the hub, the spool and the axial surface of the cover.

14. The seatbelt retractor of claim 9, wherein the intermediate portion of the band is in an interior of the hub and extends out from the hub in one direction to the first end portion and in a second direction to the second end portion, each of the first and second end portions having a first segment extending from the intermediate portion circumferentially around an outer periphery of the hub, a U-turn segment extending from the first segment and a second segment extending from the U-turn segment, the second segments being spirally wound within the spool.

15. The seatbelt retractor of claim 14, wherein the spool is configured to rotate relative to the locking disk once the load on the seatbelt webbing reaches an target load, a length of the first segments corresponding to the target load, the length and corresponding target load being adjustable prior to use of the belt retractor via rotation of one of the spool and the locking disk relative to the other of the spool and the locking disk.

16. The seatbelt retractor of claim 1, wherein the band extends about the torsion bar.

17. The seatbelt retractor of claim 1, wherein the band extends through a slot in the torsion bar.

18. The seatbelt retractor according to claim 1, wherein the band comprises a plurality of segments along an entire length of the band, at least one of the segments having different material properties than at least one of the other segments, the segmented band being configured to produce a smooth, non-stepwise load absorption characteristic curve for the segmented band.

19. The seatbelt retractor according to claim 1, wherein the band has a rounded rectangular shape in cross-section.

20. The seatbelt retractor according to claim 1, wherein an axial width of the band varies along a length of the band.
